(19) United States
(12) Patent Application Publication
(10) Pub. No.: US 2005/0137766 A1
(43) Pub. Date: Jun. 23, 2005

(54) Vehicle integrated control system

(75) Inventors: Tsuneo Miyakoshi, Toyota-shi (JP); Hiroshi Mizuno, Toyota-shi (JP); Hideki Takamatsu, Anjo-shi (JP); Hirotada Otake, Susono-shi (JP); Masami Kondo, Toyota-shi (JP); Katsuyuki Kawai, Higashikamo-gun (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/009,467

(22) Filed: Dec. 13, 2004

(30) Foreign Application Priority Data
Dec. 19, 2003 (JP) 2003-423508

(51) Int. Cl. B62D 6/00

(52) U.S. Cl. 701/36; 701/41

(57) ABSTRACT

An integrated control system includes a main control system (accelerator) controlling a driving system, a main control system (brake) controlling a brake system, and a main control system (steering) controlling a steering system, based on manipulation by a driver, as well as an adviser unit generating and providing information to be used at each main control system based on environmental information around the vehicle or information on a driver. The advisor unit outputs to the main control system (accelerator) sudden acceleration/deceleration risk information having the risk set to “high” when the vehicle is parked in a parking lot, based on information from a navigation device or a surroundings monitoring sensor. The main control system (accelerator) selects a parking state property map based on the sudden acceleration/deceleration risk information having the risk set to “high”, and calculates a target driving force smaller than that corresponding to accelerator pressing by the driver.

This nonprovisional application is based on Japanese Patent Application No. 2003-423508 filed with the Japan Patent Office on Dec. 19, 2003, the entire contents of which are hereby incorporated by reference.

### FIELD OF THE INVENTION

The present invention relates to a system controlling a plurality of actuators incorporated in a vehicle, and more particularly, a system controlling in an integrated manner a plurality of actuators with the possibility of mutual interference.

### DESCRIPTION OF THE BACKGROUND ART

There has been an increasing trend in recent years towards incorporating many types of motion control devices in the same vehicle to control the motion of the vehicle. The effect produced by each of the different types of motion control devices may not always emerge in a manner independent of each other at the vehicle. There is a possibility of mutual interference. It is therefore important to sufficiently organize the interaction and coordination between respective motion control devices in developing a vehicle that incorporates a plurality of types of motion control devices.

For example, when it is required to incorporate a plurality of types of motion control devices in one vehicle in the development stage of a vehicle, it is possible to develop respective motion control devices independently of each other, and then implement the interaction and coordination between respective motion control devices in a supplemental or additional manner.

In the case of developing a plurality of types of motion control devices in the aforesaid manner, organization of the interaction and coordination between respective motion control devices requires much time and effort.

With regards to the scheme of incorporating a plurality of types of motion control devices in a vehicle, there is known the scheme of sharing the same actuator among the motion control devices. This scheme involves the problem of how the contention among the plurality of motion control devices,.when required to operate the same actuator at the same time, is to be resolved.

In the above-described case where the interaction and coordination among a plurality of motion control devices are to be organized in a supplemental or additional manner after the motion control devices are developed independently of each other, it is difficult to solve the problem set forth above proficiently. In practice, the problem may be accommodated only by selecting an appropriate one of the plurality of motion control devices with precedence over the others, and dedicate the actuator to the selected motion control device alone.

An approach related to the problem set forth above in a vehicle incorporating a plurality of actuators to drive a vehicle in the desired behavior is disclosed in the following publications.

Japanese Patent Laying-Open No. 5-85228 (Document 1) discloses an electronic control system of a vehicle that can reduce the time required for development, and that can improve the reliability, usability, and maintenance feasibility of the vehicle. This electronic control system for a vehicle includes elements coacting for carrying out control tasks with reference to engine power, drive power and braking operation, and elements for coordinating the coaction of the elements to effect a control of operating performance of the motor vehicle in correspondence to a request of the driver. Respective elements are arranged in the form of a plurality of hierarchical levels. At least one of the coordinating elements of the hierarchical level is adapted for acting on the element of the next hierarchical level when translating the request of the driver into a corresponding operating performance of the motor vehicle thereby acting on a pre-given subordinate system of the driver-vehicle system while providing the performance required from the hierarchical level for this subordinate system.

By organizing the entire system in a hierarchy configuration in accordance with this electronic control system for a vehicle, an instruction can be conveyed only in the direction from an upper level to a lower level. The instruction to execute the driver's request is transmitted in this direction. Accordingly, a comprehensible structure of elements independent of each other is achieved. The linkage of individual systems can be reduced to a considerable level. The independency of respective elements allows the individual elements to be developed concurrently at the same time. Therefore, each element can be developed in accordance with a predetermined object. Only a few interfaces with respect to the higher hierarchical level and a small number of interfaces for the lower hierarchical level have to be taken into account. Accordingly, optimization of the totality of the driver and the vehicle electronic control system with respect to energy consumption, environmental compatibility, safety and comfort can be achieved. As a result, a vehicle electronic control system can be provided, allowing reduction in the development time, and improvement in reliability, usability, and maintenance feasibility of a vehicle.

Japanese Patent Laying-Open No. 2003-191774 (Document 2) discloses a integrated type vehicle motion control device adapting in a hierarchy manner a software configuration for a device that controls a plurality of actuators in an integrated manner to execute motion control of a plurality of different types in a vehicle, whereby the hierarchy structure is optimized from the standpoint of practical usage. This integrated vehicle motion control device controls a plurality of actuators in an integrated manner through a computer based on information related to driving a vehicle by a driver to execute a plurality of types of vehicle motion control for the vehicle. At least the software configuration among the hardware configuration and software configuration includes a plurality of elements organized in hierarchy in a direction from the driver towards the plurality of actuators. The plurality of elements include: (a) a control unit determining the target vehicle state quantity based on the driving-related information at the higher level; and (b) an execution unit receiving the determined target vehicle state quantity as an instruction from the control unit to execute the received instruction via at least one of the plurality of actuators at the lower level. The control unit includes an upper level control unit and a lower level control unit, each issuing an instruction to control the plurality of actuators in an integrated manner. The upper level control unit determines a first target vehicle state quantity based on the driving-related information without taking into account the dynamic behavior of the vehicle, and supplies the determined first target vehicle state quantity to the lower level control unit. The lower level control unit determines the second target vehicle state quantity based on the first target vehicle state quantity received from the upper level control unit, taking into account the dynamic behavior of the vehicle, and supplies the determined second target vehicle state quantity to the execution unit. Each of the upper level control unit, the lower level control unit, and the execution unit causes the computer to execute a plurality of modules independent of each other on the software configuration to realize unique functions thereof.

In accordance with this integrated type vehicle motion control device, at least the software configuration among the hardware configuration and software configuration is organized in a hierarchy structure so as to include: (a) a control unit determining a target vehicle state quantity based on driving-related information at the higher level in the direction from the driver to the plurality of actuators; and (b) an execution unit receiving the determined target vehicle state quantity as an instruction from the control unit to execute the received instruction via at least one of the plurality of actuators at the lower level. In other words, at least the software configuration is organized in hierarchal levels such that the control unit and the execution unit are separated from each other in this vehicle motion control device. Since the control unit and the execution unit are independent of each other from the software configuration perspective, respective stages of development, designing, design modification, debugging and the like can be effected without influencing the other. Respective stages can be carried out concurrently with each other. As a result, the period of the working stage required for the entire software configuration can be readily shortened by the integrated vehicle motion control device.

In addition, a technique related to achieving a desired behavior of a vehicle in parking or starting the same is disclosed in the following publication.

Japanese Patent Laying-Open No. 2000-136738 (Document 3) discloses a vehicle parking operation support device for supporting a driving operation by a driver at the time of parking or starting of the vehicle, aiming to improve safety of the vehicle by preventing collision of the vehicle to an obstacle. The vehicle parking operation support device has a running control mechanism controlling a running state based on the driving operation by the driver, and includes vehicle entrance/leaving state determination means for determining whether the vehicle is in an entrance state or in a leaving state, and modification means for modifying a control characteristic of the running control mechanism based on the driving operation when the vehicle is determined to be in the entrance state or in the leaving state.

According to the vehicle parking operation support device, whether the vehicle is in the entrance state or in the leaving state is determined. Here, the entrance state refers to a state that a running vehicle is about to be parked by the driver. Meanwhile, the leaving state refers to a state that a parked vehicle is about to be started by the driver. When the vehicle is in the entrance state or the leaving state, the control characteristic of the running control mechanism based on the driving operation is modified. When the control characteristic of the running control mechanism is modified, the running control mechanism quickly reacts to the driving operation, or alternatively, it is less likely to react thereto. Therefore, excellent operability or safety is achieved in the driving operation in parking or starting the vehicle. In other words, it is not necessary to run the vehicle in high speed or to widely open the throttle valve in parking or starting the vehicle. Accordingly, even when an accelerator pedal is considerably pressed down at the time of parking or starting, wide opening of the throttle valve can be prevented in order not to run the vehicle in high speed.

Japanese Patent Laying-Open No. 10-272913 (Document 4) discloses a control device for a vehicle suitably adapting an operation of an on-vehicle device in accordance with a characteristic of a facility. The control device for a vehicle includes map information storage means for storing map information including facility information, car position detecting means for detecting a position of one's own car, presence-in-facility determination means for determining whether or not one's own car is located within the facility based on the map information of the map information storage means and the position of one's own car detected by the car position detecting means, facility information obtaining means for obtaining information on a facility where one's own car is located when it is determined that one's own car is within the facility by the presence-in-facility determination means, and control means for controlling an operation of one or more on-vehicle device incorporated in the vehicle based on the information on the facility obtained by the facility information obtaining means.

According to the control device for a vehicle, whether or not one's own car is located within the facility is determined. If the car is located within the facility, an operation of the on-vehicle device incorporated in the vehicle is controlled based on the information on the facility. Accordingly, the operation of the on-vehicle device can be controlled in accordance with a characteristic unique to the facility, so as to be suitably adapted to the facility. In this manner, a vehicle speed can be controlled in accordance with whether the car is inside or outside the facility. Specifically, when the vehicle is located within a facility where a vehicle speed is to be restricted, such as a variety of parking lots or gas stations, the fact that the vehicle is inside such a facility is recognized, and the vehicle speed is suppressed so as not to exceed an upper limit. Even if a driver inappropriately manipulates the accelerator, inadvertent acceleration of the vehicle can be suppressed, thereby effectively avoiding overrun or the like.

The electronic control system for a vehicle disclosed in Document 1 is disadvantageous in that the entire controllability of the vehicle is degraded when in the event of system failure at the upper hierarchical level since the entire system employs a hierarchy structure.

The integrated type vehicle motion control device disclosed in Document 2 specifically discloses the hierarchy structure of Document 1, and is directed to optimization of the hierarchy structure from the standpoint of practical usage. Specifically, the software configuration is divided into at least a control unit and an execution unit, independent of each other in the hierarchy level. Although this integrated type vehicle motion control device is advantageous from the standpoint of concurrent processing of development by virtue of independency thereof, the issue of depending upon the basic concept of hierarchy is not yet resolved.

According to the vehicle parking operation support device disclosed in Document 3, an assist switch is provided in the vehicle for manipulation by the driver. The assist switch is turned on by manipulation at the time of parking of the vehicle (parking) or starting of the parked vehicle (start). When the assist switch is turned on, the driving operation by the driver at the time of parking or start is assisted (even when the accelerator pedal is greatly pressed down, the engine is controlled so as to prevent wide opening of the throttle valve). On the other hand, if the driver forgets turning on of the assist switch, the vehicle is suddenly accelerated when the driver presses down the accelerator pedal in parking.

In addition, the control device for a vehicle disclosed in Document 4 serves to detect that the vehicle is currently located within the facility (such as a parking lot, a gas station, etc.) based on the information from the navigation device (current position information and map information), so as to restrict acceleration, thereby avoiding overrun or the like. Accordingly, if the vehicle is to be parked in a large-scale parking lot, acceleration is restricted in a passage within the parking lot until the vehicle arrives at an actual parking space. In addition, Document 4 includes no mention on canceling acceleration restriction.

Unlike the hierarchical control configuration (Document 1) or the hierarchy achieved by dividing the software configuration into at least the control unit and the execution unit (Document 2), in Documents 3 and 4, a computer controlling the engine merely restricts a position of the throttle with respect to the accelerator pedal position when a prescribed condition is satisfied, without exerting integrated control of the vehicle. Therefore, neither of Documents 3 and 4 relates to integrated or hierarchical control of the vehicle.

### SUMMARY OF THE INVENTION

The present invention was made to solve the above-described problems. An object of the present invention is to provide a vehicle integrated control system capable of avoiding inadvertent sudden acceleration/deceleration and readily accommodating addition of a vehicle control function, aiming to improve fail-safe performance without realizing a system for integrated control of the entire vehicle.

According to the present invention, a vehicle integrated control system includes a plurality of control units controlling a running state of a vehicle based on a manipulation request, and a processing unit generating information to be used at respective control units in prohibiting an operation of a vehicle, based on information on a position of the vehicle and providing the generated information to each control unit. Each control unit includes a sensing unit for sensing an operation request with respect to at least one control unit, and a calculation unit for calculating information related to a control target to manipulate an actuator set in correspondence with each unit using at least one of the information generated at the processing unit and the sensed operation request.

According to the present invention, the plurality of control units include, for example, one of a driving system control unit, a brake system control unit, and a steering system control unit. The driving system control unit senses an accelerator pedal manipulation that is a request of a driver through the sensing unit to generate a control target of the driving system corresponding to the accelerator pedal manipulation using a driving basic driver model, whereby a power train that is an actuator is controlled by a controller. The brake system control unit senses a brake pedal manipulation that is a request of the driver through the sensing unit to generate a control target of the brake system corresponding to the brake pedal manipulation using a brake basic driver model, whereby a brake device that is an actuator is controlled by the controller. The steering system control unit senses a steering manipulation that is a request of the driver through the sensing unit to generate a control target of the steering system corresponding to the steering manipulation using a steering basic driver model, whereby a steering device that is an actuator is controlled by the controller. The vehicle integrated control system includes a processing unit that operates parallel to the driving system control unit, the brake system control unit and the steering system control unit that operate autonomously. For example, the processing unit generates: 1) information to be used at respective controllers based on environmental information around the vehicle or information related to the driver, and provides the generated information to respective control units; 2) information to be used at respective controllers to cause the vehicle to realize a predetermined behavior, and provides the generated information to respective control units; and 3) information to be used at respective controllers based on the current dynamic state of the vehicle, and provides the generated information to respective control units. Each control unit determines as to whether or not such input information, in addition to the driver's request from the processing unit, is to be reflected in the motion control of the vehicle, and to what extent, if to be reflected. Each control unit also corrects the control target, and transmits the information among respective control units. Since each control unit operates autonomously, the power train, brake device and steering device are controlled eventually at respective control units based on the eventual driving target, braking target and steering target calculated from the driver's manipulation information sensed by the sensing unit, the information input from the processing unit, and information transmitted among respective control units. Thus, the driving system control unit corresponding to a “running” operation that is the basic operation of the vehicle, the brake system control unit corresponding to a “stop” operation, and the steering system control unit corresponding to a “turning” operation are provided operable in a manner independent of each other. The processing unit is applied with respect to these control units such that the driving operation corresponding to the vehicle environment, driving support for the driver, and vehicle dynamic motion control can be conducted automatically in a parallel manner. Accordingly, decentralized control is allowed without a master control unit that is positioned at a higher level than the other control units, and the fail safe faculty can be improved. Furthermore, by virtue of autonomous operation, development is allowed on the basis of each control unit or each processing unit. In the case where a new driving support function is to be added, the new function can be implemented by just adding a processing unit or modifying an existing processing unit. As a result, a vehicle integrated control system can be provided, having the fail-safe performance improved and capable of readily accommodating addition of a vehicle control function, based on integrated control, without realizing the entire control of the vehicle by, for example, one master ECU as in the conventional case. In addition, as this processing unit, a unit generating information to be used in each control unit in prohibiting a sudden operation of a vehicle and providing the generated information to each control unit is arranged. For example, when the vehicle is parked in a vacant parking space in a parking lot, information that sudden acceleration/deceleration risk is “high” is generated and provided to each control unit. Upon receiving such information, each control unit controls the driving system control unit, the brake system control unit and the steering system control unit so as to prohibit a sudden operation. In this manner, the vehicle integrated control system capable of avoiding inadvertent sudden acceleration/deceleration can be provided.

Preferably, the processing unit senses position information of the vehicle, and generates information to be used in each control unit in prohibiting a start operation or a stop operation, based on the position information of the vehicle.

According to the present invention, when the vehicle is located in a parking lot or at a gas station as a result of sensing by a car navigation device, a degree of freedom in driving is restricted due to an obstacle around the vehicle. Accordingly, sudden start of the vehicle caused by misoperation by the driver should be avoided. Here, information to be used in each control unit in prohibiting the sudden start operation or the sudden stop operation is generated based on the position information of the vehicle. Therefore, depending on a position of a vehicle, the sudden start operation or the sudden stop operation of the vehicle can be avoided despite of misoperation by the driver.

Further preferably, the processing unit senses that the vehicle is positioned at a specific place where a degree of freedom in running of the vehicle is restricted, based on the position information of the vehicle and senses an obstacle around the vehicle. When the vehicle is positioned at the specific place and when an obstacle around the vehicle is sensed, the processing unit generates information to be used in each control unit in prohibiting the start operation or the stop operation.

According to the present invention, if a vehicle is in a parking lot where a driver himself/herself should find a space and park a car and there is an obstacle present around the vehicle, it can be determined that this vehicle is being parked in a vacant parking space. Here, information to be used in each control unit in prohibiting the sudden start operation or the sudden stop operation is generated. Therefore, the sudden start operation or the sudden stop operation of the vehicle can be avoided despite of misoperation by the driver during the parking operation.

Further preferably, the processing unit further includes a canceling unit generating information for canceling prohibition of the start operation or the stop operation.

According to the present invention, the vehicle can return to normal running based on the information for canceling prohibition of the sudden start operation or the sudden stop operation generated by the canceling unit.

Further preferably, the canceling unit senses an operation request with respect to at least one control unit and generates information for canceling prohibition of the start operation or the stop operation based on the operation request.

According to the present invention, for example, by canceling prohibition of the sudden start operation or the sudden stop operation in response to manipulation of a cancellation switch by the driver, the vehicle can return to normal running.

Further preferably, the canceling unit senses a speed of the vehicle, and generates information for canceling prohibition of the start operation or the stop operation based on the speed of the vehicle.

According to the present invention, by canceling prohibition of the sudden start operation or the sudden stop operation in response to the fact that the vehicle speed is larger than a predetermined vehicle speed (that is, the vehicle leaves the parking lot and is on a road, etc.), the vehicle can return to normal running.

Further preferably, the canceling unit senses a continued state of prohibition of the start operation or the stop operation, and generates information for canceling prohibition of the start operation or the stop operation based on the continued state.

According to the present invention, for example, the continued state of prohibition of the sudden start operation or the sudden stop operation is sensed based on a distance of travel or a time period of travel. When such a continued state lasts long (that is, an operation for parking has already been completed, etc.), the vehicle can return to normal running by canceling prohibition of the sudden start operation or the sudden stop operation.

Further preferably, the continued state represents a quantity of state based on a distance of travel or a time period of travel.

According to the present invention, the continued state of prohibition of the sudden start operation or the sudden stop operation can be sensed based on a distance of travel or a time of running.

Further preferably, the vehicle integrated control system gradually carries out cancel of a state in which the start operation or the stop operation is prohibited.

According to the present invention, the state in which the sudden start operation or the sudden stop operation is prohibited is gradually cancelled. Therefore, even if the driver greatly presses down the accelerator pedal at the time of canceling, sudden start of the vehicle can be avoided.

Further preferably, the vehicle integrated control system informs a driver of any one of a state in which the start operation or the stop operation is prohibited and a state in which prohibition has been cancelled.

According to the present invention, in the state in which the sudden start operation or the sudden stop operation is prohibited, a driving force not corresponding to the degree of pressing of the accelerator pedal by the driver is merely generated, and this may cause doubt of the driver. Accordingly, any one of the state in which the sudden start operation or the sudden stop operation is prohibited and the state in which prohibition has been cancelled is notified to the driver by displaying on an instrument panel, for example, thereby suppressing doubt of the driver.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a vehicle in which the vehicle integrated control system of the present embodiment is incorporated.

FIG. 2 is a schematic diagram of a configuration of the vehicle integrated control system according to the present embodiment.

FIG. 3 is a schematic diagram of a configuration of a main control system (1).

FIG. 4 is a diagram representing the input and output of signals in a main control system (1).

FIG. 5 is a diagram representing the input and output of signals in a main control system (2).

FIG. 6 is a diagram representing the input and output of signals in a main control system (3).

FIG. 7 is a conceptual view of a configuration of an integrated system in exerting sudden acceleration/deceleration restriction control.

FIG. 8 illustrates a property map of an accelerator pedal pressing degree-driving force in a normal state.

FIG. 9 illustrates a property map of an accelerator pedal pressing degree-driving force in a parking state.

FIG. 10 is a flowchart showing a control configuration of a program executed in an ECU implementing an advisor unit.

FIG. 11 is a flowchart showing a control configuration of a program executed in an ECU implementing a main control system (1).

### DESCRIPTION OF THE PREFERRED EMBODIMENTS

An embodiment of the present invention will be described hereinafter with reference to the drawings. The same elements have the same reference characters allotted. Their label and function are also identical. Therefore, detailed description thereof will not be repeated.

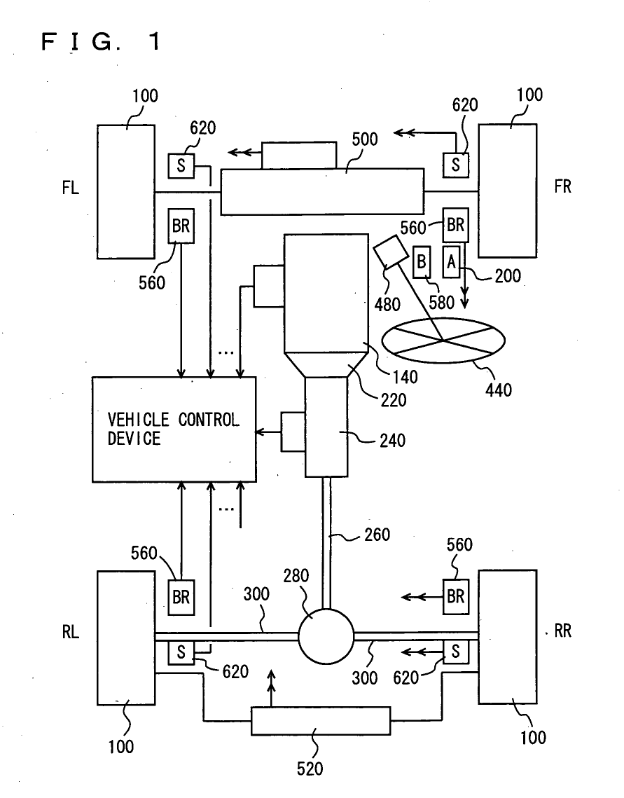

Referring to the block diagram of FIG. 1, a vehicle integrated control system according to an embodiment of the present invention has an internal combustion engine incorporated in a vehicle as a driving power source. The driving power source is not restricted to an internal combustion engine, and may be an electric motor alone, or a combination of an engine and an electric motor. The power source of the electric motor may be a secondary battery or a cell.

The vehicle includes wheels 100 at the front and back of respective sides. In FIG. 1, “FL” denotes a front-left wheel, “FR” denotes a front-right wheel, “RL” denotes a left-rear wheel, and “RR” denotes a rear-right wheel.

The vehicle incorporates an engine 140 as a power source. The operating state of engine 140 is electrically controlled in accordance with the amount or level by which the accelerator pedal (which is one example of a member operated by the driver related to the vehicle drive) is manipulated by the driver. The operating state of engine 140 is controlled automatically, as necessary, irrespective of the manipulation of accelerator pedal 200 by the driver (hereinafter referred to as “driving operation” or “accelerating operation”).

The electric control of engine 140 may be implemented by, for example, electrically controlling an opening angle (that is, a throttle opening) of a throttle valve disposed in an intake manifold of engine 140, or by electrically controlling the amount of fuel injected into the combustion chamber of engine 140.

The vehicle of the present embodiment is a rear-wheel-drive vehicle in which the right and left front wheels are driven wheels, and the right and left rear wheels are driving wheels. Engine 140 is connected to each of the rear wheels via a torque converter 220, a transmission 240, a propeller shaft 260 and a differential gear unit 280 as well as a drive shaft 300 that rotates with each rear wheel, all arranged in the order of description. Torque converter 220, transmission 240, propeller shaft 260 and differential gear 280 are power transmitting elements that are common to the right and left rear wheels.

Transmission 240 includes an automatic transmission that is not shown. This automatic transmission electrically controls the gear ratio at which the revolution speed of engine 140 is changed to the speed of rotation of an output shaft of transmission 240.

The vehicle further includes a steering wheel 440 adapted to be turned by the driver. A steering reaction force applying device 480 electrically applies a steering reaction force corresponding to a turning manipulation by the driver (hereinafter, referred to as “steering”) to steering wheel 440. The level of the steering reaction force is electrically controllable.

The direction of the right and left front wheels, i.e. the front-wheel steering angle is electrically altered by a front steering device 500. Front steering device 50 controls the front-wheel steering angle based on the angle, or steering wheel angle, by which steering wheel 440 is turned by the driver. The front-rear steering angle is controlled automatically, as necessary, irrespective of the turning operation. In other words, steering wheel 440 is mechanically insulated from the right and left front wheels.

The direction of the left and right wheels, i.e., the rear-wheel steering angle is electrically altered by a rear steering device 520, likewise the front-wheel steering angle.

Each wheel 100 is provided with a brake 560 that is actuated so as to restrict its rotation. Each brake 560 is electrically controlled in accordance with the operated amount of a brake pedal 580 (which is one example of a member operated by the driver related to vehicle braking), and also controlled individually for each wheel 100 automatically.

In the present vehicle, each wheel 100 is suspended to the vehicle body (not shown) via each suspension 620. The suspending characteristics of respective suspension 620 is electrically controllable individually.

The constituent elements of the vehicle set forth above include an actuator adapted to be operated so as to electrically actuate respective elements as follows:
(1) An actuator to electrically control engine 140;
(2) An actuator to electrically control transmission 240;
(3) An actuator to electrically control steering reaction force applying device 480;
(4) An actuator to electrically control front steering device 500;
(5) An actuator to electrically control rear steering device 520;
(6) A plurality of actuators provided in association with respective brakes 560 to electrically control the braking torque applied to each wheel by a corresponding brake 560 individually;
(7) A plurality of actuators provided in association with respective suspensions 620 to electrically control the suspending characteristics of a corresponding suspension 620 individually.

As shown in FIG. 1, the vehicle integrated control system is incorporated in a vehicle having the aforesaid plurality of actuators connected. The motion control device is actuated by the electric power supplied from a battery not shown (which is an example of the vehicle power supply).

Additionally, an accelerator pedal reaction force applying device may be provided for accelerator pedal 200. In this case, an actuator to electrically control such an accelerator pedal reaction force applying device is to be provided.

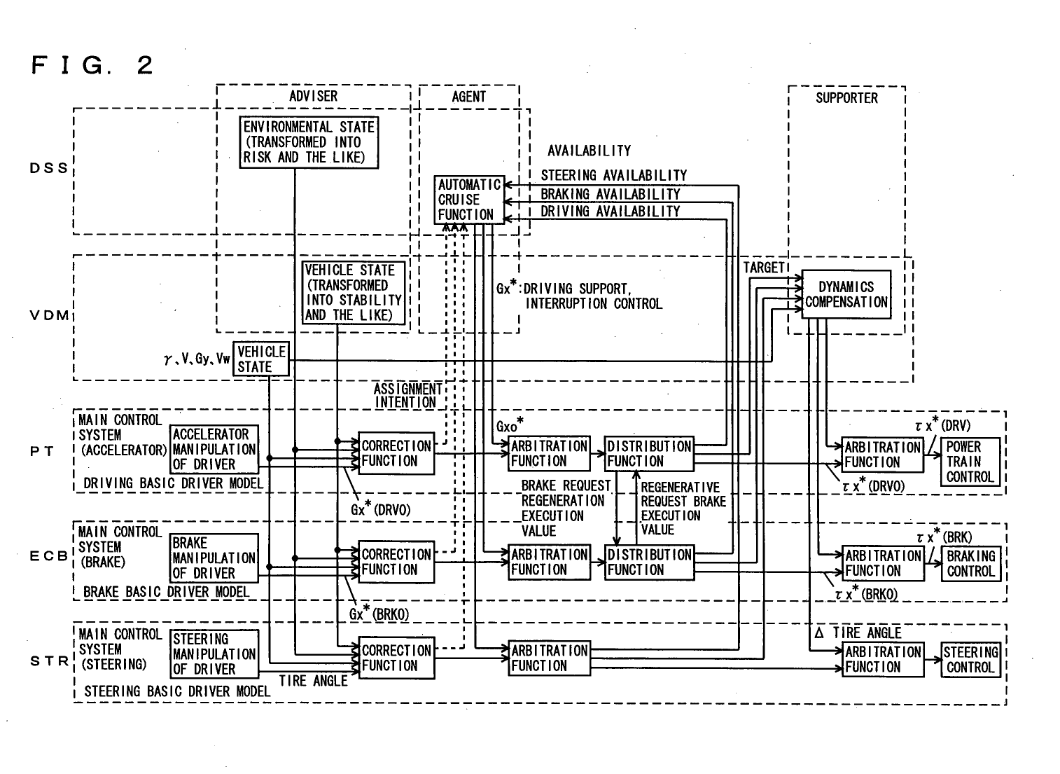

FIG. 2 is a schematic diagram of a configuration of the vehicle integrated control system. The vehicle integrated control system is formed of three basic control units, i.e. a main control system (1) as the driving system control unit, a main control system (2) as the brake system control unit, and a main control system (3) as the steering system control unit.

At main control system (1) identified as the driving system control unit, a control target of the driving system corresponding to accelerator pedal manipulation is generated using the driving basic driver model, based on the accelerator pedal manipulation that is the sensed request of the driver, whereby the actuator is controlled. At main control system (1), the input signal from the sensor to sense the accelerator pedal operated level of the driver (stroke) is analyzed using the drive basic model to calculate a target longitudinal acceleration Gx* (DRV0). The target longitudinal acceleration Gx* (DRV0) is corrected by a correction functional block based on the information from an adviser unit. Further, target longitudinal acceleration Gx* (DRV0) is arbitrated by the arbitration functional block based on the information from an agent unit. Further, the driving torque and braking torque is distributed with main control system (2), and the target driving torque τx* (DRV0) of the driving side is calculated. Further, the target driving torque τx* (DRV0) is arbitrated by the arbitration functional block based on information from a supporter unit, and a target driving torque τx* (DRV) is calculated. The power train (140, 220, 240) is controlled so as to develop this target drive torque τx* (DRV).

At main control system (2) identified as the brake system control unit, a control target of the brake system corresponding to the brake pedal manipulation is generated using the brake basic driver model based on the brake pedal manipulation that is the sensed request of the driver, whereby the actuator is controlled.

At main control system (2), the input signal from a sensor to sense the brake pedal manipulated level (depression) of the driver is analyzed using a brake basic model to calculate a target longitudinal acceleration Gx* (BRK0). At main control system (2), the target longitudinal acceleration Gx* (BRK0) is corrected by a correction functional block based on the information from the adviser unit. Further at main control system (2), the target longitudinal acceleration Gx* (BRK0) is arbitrated by the arbitration functional block based on the information from the agent unit. Further at main control system (2), the driving torque and the braking torque are distributed with main control system (1), and the target braking torque τx* (BRK0) of the braking side is calculated. Further, the target braking torque τx* (BRK0) is arbitrated by the arbitration functional block based on the information from the support unit, and target braking torque τx* (BRK) is calculated. The actuator of brake 560 is controlled so as to develop this target braking torque τx* (BRK).

At main control system (3) identified as the steering system control unit, a control target of the steering system corresponding to the steering manipulation is generated using the steering brake basic driver model based on the steering manipulation that is the sensed request of the driver, whereby the actuator is controlled.

At main control system (3), an input signal from the sensor to sense the steering angle of the driver is analyzed using a steering basic model to calculate a target tire angle. The target tire angle is corrected by the correction functional block based on the information from the adviser unit. Further, the target tire angle is arbitrated by the arbitration functional block based on the information from the agent unit. Further, the target tire angle is arbitrated by the arbitration functional block based on the information from the supporter unit to calculate the target tire angle. The actuators of front steering device 500 and rear steering device 520 are controlled so as to develop the target tire angle.

Furthermore, the present vehicle integrated control system includes a plurality of processing units parallel to main control system (1) (driving system control unit), main control system (2) (brake system unit) and main control system (3) (steering system control unit), operating autonomously. The first processing unit is an adviser unit with an adviser function. The second processing unit is an agent unit with an agent function. The third processing unit is a support unit with a supporter function.

The adviser unit generates and provides to respective main control systems information to be used at respective main control systems based on the environmental information around the vehicle or information related to the driver. The agent unit generates and provides to respective main control systems information to be used at respective main control systems to cause the vehicle to realize a predetermined behavior. The supporter unit generates and provides to respective main control systems information to be used at respective main control systems based on the current dynamic state of the vehicle. At respective main control systems, determination is made as to whether or not such information input from the adviser unit, the agent unit and the supporter unit (information other than the request of the driver) is to be reflected in the motion control of the vehicle, and to what extent, if to be reflected. Furthermore, the control target is corrected, and/or information is transmitted among respective control units. Since each main control system operates autonomously, the actuator of the power train, the actuator of brake device and the actuator of steering device are controlled eventually at respective control units based on the eventual driving target, braking target and steering target calculated by the sensed manipulation information of the driver, information input from the adviser unit, agent unit and supporter unit, and information transmitted among respective main control systems.

Specifically, the adviser unit generates information representing the degree of risk with respect to the vehicle operation property based on the frictional resistance (μvalue) of the road on which the vehicle is running, the outdoor temperature and the like as the environmental information around the vehicle, and/or generates information representing the degree of risk with respect to the manipulation of the driver based on the fatigue level of the driver upon shooting a picture of the driver. Information representing the degree of risk is output to each main control system. This information representing the degree of risk is processed at the adviser unit so the information can be used at any of the main control systems. At each main control system, the process is carried out as to whether or not to reflect the information related to the input risk for the vehicle motion control, in addition to the request of the driver from the processing unit, and to what extent the information is to be reflected, and the like.

Specifically, the agent unit generates information to implement an automatic cruise function for the automatic drive of vehicle. The information to implement the automatic cruise function is output to each main control system. At each main control system, the process is carried out as to whether or not to reflect the input information to implement the automatic cruise function, in addition to the request of the driver from the processing unit, and to what extent the information is to be reflected, and the like.

Further preferably, the supporter unit identifies the current dynamic state of the vehicle, and generates information to modify the target value at each main control system. The information to modify the target value is output to each main control system. At each main control system, the process is carried out as to whether or not to reflect the input information to modify the target value based on the dynamic state for the vehicle motion control, in addition to the request of the driver from the processing unit, and to what extent the information is to be reflected, and the like.

As shown in FIG. 2, the basic control units of main control system (1), main control system (2) and main control system (3), and the support unit of the adviser unit, agent unit, and supporter unit are all configured so as to operate autonomously. Main control system (1) is designated as the PT (Power Train) system. Main control system (2) is designated as the ECB (Electronic Controlled Brake) system. Main control system (3) is designated as the STR (Steering) system. A portion of the adviser unit and the portion of the agent unit are designated as the DSS (Driving Support System). A portion of the adviser unit, a portion of the agent unit, and a portion of the supporter unit are designated as the VDM (Vehicle Dynamics Management) system. Interruption control for interruption of control executed at main control system (1), main control system (2) and main control system (3) from the agent unit (automatic cruise function) is conducted in the control shown in FIG. 2.

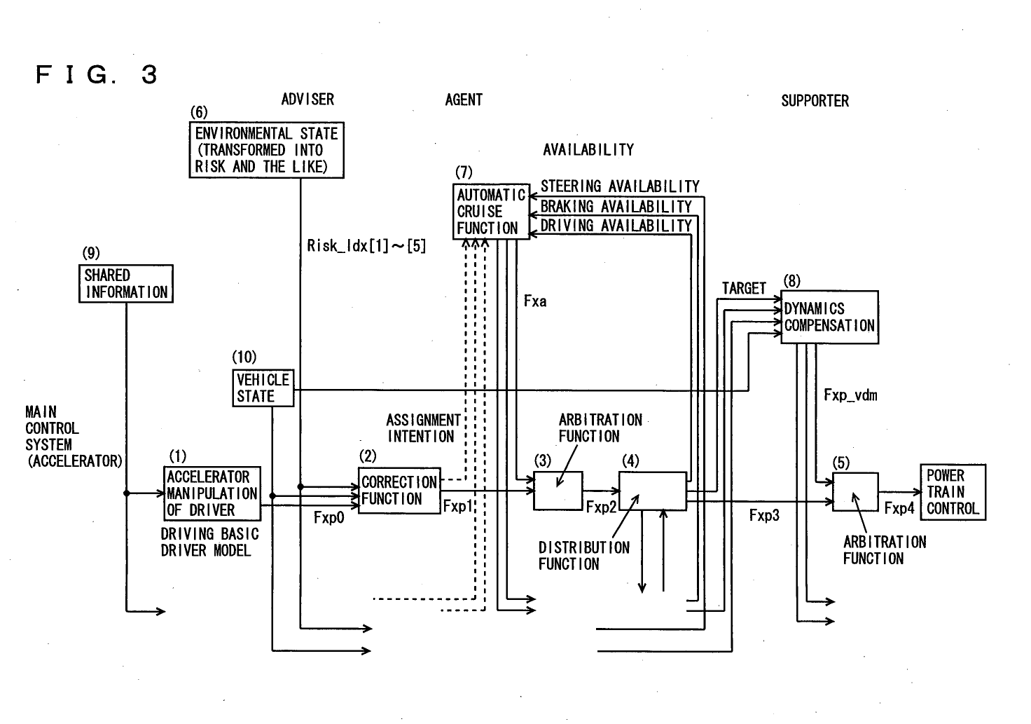

Main control system (1) (driving system control unit) will be described in further detail with reference to FIG. 3. Although the designation of the variable labels may differ in FIGS. 3 and et seq., there is no essential difference thereby in the present invention. For example, the interface is designated as Gx* (acceleration) in FIG. 2 whereas the interface is designated as Fx (driving force) in FIGS. 3 and et seq. This corresponds to F (force)=m (mass)×α(acceleration), where the vehicle mass (m) is not the subject of control, and is not envisaged of being variable. Therefore, there is no essential difference between Gx* (acceleration) of FIG. 2 and Fx (driving force) of FIGS. 3 and et seq.

Main control system (1) that is the unit to control the driving system receives information such as the vehicle velocity, gear ratio of the transmission and the like identified as shared information (9). Using such information and the driving basic driver model, Fxp0 representing the target longitudinal direction acceleration is calculated as the output of the driving basic driver model. The calculated Fxp0 is corrected to Fxp1 by a correction functional unit (2) using environmental state (6) that is the risk degree information (index) as an abstraction of risk and the like, input from the adviser unit. Information representing the intention of assignment with respect to realizing an automatic cruise function is output from correction functional unit (2) to agent unit (7). Using Fxp1 corrected by correction functional unit (2) and information for implementation of automatic cruise functional unit (7), input from the agent unit, the information (Fxp1, Fxa) is arbitrated by arbitration functional unit (3) to Fxp2.

The dividing ratio of the driving torque and braking torque is calculated between main control system (1) that is the unit controlling the driving system and main control system (2) that is the unit driving the brake system. At main control system (1) corresponding to the driving unit side, Fxp3 of the driving system is calculated. FxB is output from distribution functional unit (4) to main control system (2), and the driving availability and target value are output to agent unit (7) and dynamic (8) that is the supporter unit, respectively.

At arbitration functional unit (5), the information is arbitrated to Fxp4 using Fxp3 output from distribution functional unit (4) and Fxp_vdm from dynamics compensation functional unit (8). Based on the arbitrated Fxp4, the power train is controlled.

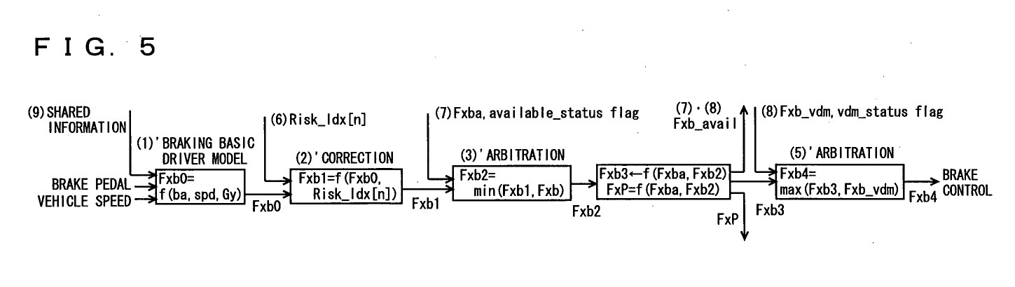

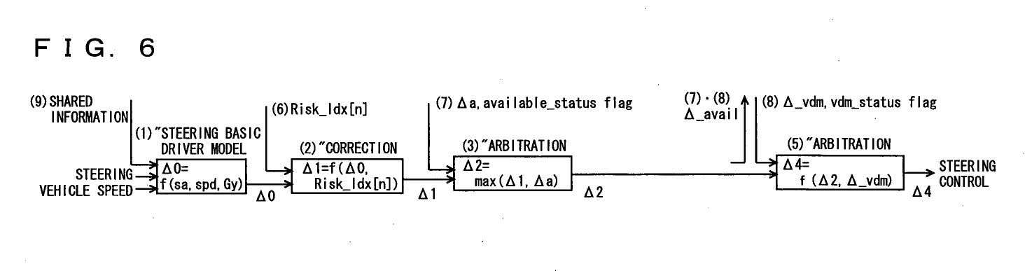

The elements shown in FIG. 3 are also present in main control system (2) and main control system (3). Since main control system (2) and main control system (3) will be described in further detail with reference to FIGS. 5-6, description on main control system (2) and main control system (3) based on drawings corresponding to main control system (1) of FIG. 3 will not be repeated.

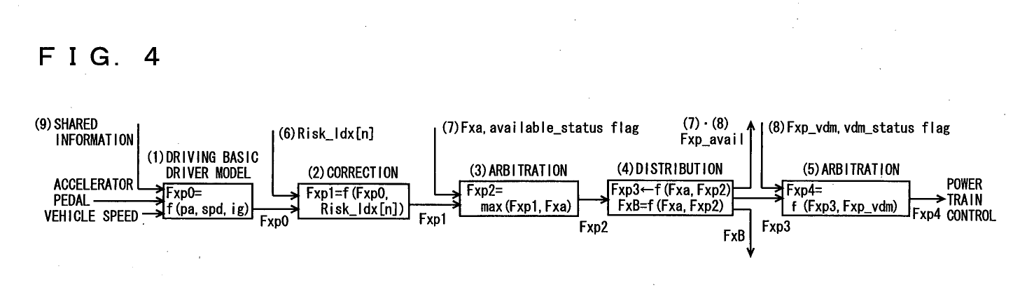

FIGS. 4-6 represent the control configuration of main control system (1), main control system (2) and main control system (3).

FIG. 4 shows a control configuration of main control system (1). Main control system (1) that covers control of the driving system is adapted by the procedures set forth below.

At driving basic driver model (1), the basic drive driver model output (Fxp0) is calculated based on HMI (Human Machine Interface) input information such as the accelerator pedal opening angle (pa), vehicle speed (spd) and gear ratio (ig) of the transmission that are shared information (9), and the like. The equation at this stage is represented by Fxp0=f(pa, spd, ig), using function f.

At correction functional unit (2), Fxp0 is corrected to output Fxp1 based on Risk_Idx [n] that is the environmental information (6) from the advisor unit (for example, information transformed into the concept of risk or the like). The equation at this stage is represented by Fxp1=f(Fxp0, Risk_Idx [n]), using function f.

Specifically, it is calculated by, for example, Fxp11=Fxp0×Risk_Idx [n]. The degree of risk is input from the advisor unit such as Risk_Idx [1]=0.8, Risk_Idx [2]=0.6, and Risk_Idx [3]=0.5.

Additionally, Fxp12 is calculated, which is a corrected version of Fxp0, based on information that is transformed into the concept of stability and the like from the vehicle state (10). The equation at this stage is represented by, for example, Fxp12=Fxp0×Stable_Idx [n]. The stability is input such as Stable_Idx [1]=0.8, Stable_Idx [2]=0.6, and Stable Idx [3]=0.5.

A smaller value of these Fxp11 and Fxp12 may be selected to be output as Fxp1.

In this correction functional unit (2), assignment intention information can be output to automatic cruise functional unit (7) that is an agent function when the driver depresses the cruise control switch. In the case where the accelerator pedal is a reaction force controllable type here, the automatic cruise intention of the driver is identified based on the driver's manipulation with respect to the accelerator pedal to output assignment intention information to automatic cruise functional unit (7).

At arbitration functional unit (3), arbitration between Fxp1 output from correction functional unit (2) and Fxa output from automatic cruise functional unit (7) of the agent unit is executed to output Fxp2 to distribution unit (4). When accompanied with additional information (flag, available_status flag) indicative of output Fxa from automatic cruise functional unit (7) being valid, the arbitration function selects Fxa that is the output from automatic cruise functional unit (7) with highest priority to calculate Fxp2. In other cases, Fxp1 that is the output from correction functional unit (2) may be selected to calculate Fxp2, or Fxp1 output from correction function unit (2) may have Fxa reflected at a predetermined degree of reflection to calculate Fxp2. The equation at this stage is represented by Fxp2=max (Fxp1, Fxa), for example, using a function “max” that selects the larger value.

At distribution functional unit (4), distribution operation is mainly effected between main control system (1) that is the driving system control unit and main control system (2) that is the brake system control unit. Distribution functional unit (4) functions to output Fxp3 to arbitration functional unit (5) for the distribution towards the driving system that is the calculated result, and outputs FxB to main control system (2) for the distribution towards the brake system that is the calculated result. Further, drive availability Fxp_avail identified as the information of the driving power source that can be output from the power train which is the subject of control of main control system (1) is provided to automatic cruise functional unit (7) identified as the agent unit and dynamics compensation functional unit (8) identified as the supporter unit. The equation at this stage is represented by Fxp3←f(Fxa, Fxp2), FxB=f(Fxa, Fxp2), using function f.

At arbitration functional unit (5), arbitration is executed between Fxp3 output from distribution functional unit (4) and Fxp_vdm output from dynamics compensation functional unit (8) to output Fxp4 to the power train controller. When accompanied with additional information (flag, vdm_status flag) indicative of Fxp_vdm output from dynamics compensation functional unit (8) being valid, the arbitration function selects Fxp_vdm that is the output from dynamics compensation functional unit (8) with highest priority to calculate Fxp4. In other cases, Fxp3 that is the output from distribution functional unit (4) can be selected to calculate Fxp4, or Fxp3 output from distribution functional unit (4) may have Fxp_vdm reflected by a predetermined degree of reflection to calculate Fxp4. The equation at this stage is represented by, for example, Fxp4=f (Fxp3, Fxp_vdm).

FIG. 5 represents the control configuration of main control system (2). Main control system (2) covering the control of the brake system is adapted by the procedure set forth below.

At the brake basic driver model (1)′, the basic braking driver model output (Fxp0) is calculated based on the HMI input information such as the brake pedal depression (ba), as well as vehicle speed (spd), that is the shared information (9), the horizontal G acting on the vehicle (Gy), and the like. The equation at this stage is represented by Fxb0=f(pa, spd, Gy), using function f.

At correction function unit (2)′, Fxb0 is corrected to output Fxb1 based on Risk_Idx [n] that is the environmental information (6) from the advisor unit (for example, information transformed into the concept of risk and the like). The equation at this stage is represented by Fxb1=f(Fxb0, Risk_Idx [n]), using function f.

More specifically, it is calculated by, for example, Fxb11=Fxb0×Risk_Idx [n]. The degree of risk is input from the advisor unit such as Risk_Idx [1]=0.8, Risk_Idx [2]=0.6, and Risk_Idx [3]=0.5.

Further, Fxb12 that is a corrected version of Fxb0 is calculated, based on information transformed into the concept of stability and the like from the vehicle state (10). It is calculated by, for example, Fxb12=Fxb0×Stable_Idx [n]. For example, Stable_Idx [1]=0.8, Stable_Idx [2]=0.6, and Stable_Idx [3]=0.5 are input.

The larger of these Fxb11 and Fxb12 may be selected to be output as Fxb1. Specifically, the output may be corrected in accordance with the distance from the preceding running vehicle sensed by a millimeter wave radar, the distance to the next corner sensed by the navigation device, or the like.

At arbitration functional unit (3)′, arbitration is executed between Fxb1 output from correction functional unit (2)′ and Fxba output from automatic cruise functional unit (7) that is the agent unit to output Fxb2 to distribution unit (4)′. When accompanied with additional information (flag, available_status flag) indicative of Fxba output from automatic cruise functional unit (7) being valid, the arbitration function selects Fxba that is the output from automatic cruise functional unit (7) with highest priority to calculate Fxb2. In other cases, Fxb1 that is the output from correction functional unit (2)′ may be selected to calculate Fxb2, or Fxb1 that is the output from correction functional unit (2)′ may have Fxba reflected by a predetermined degree of reflection to calculate Fxb2. The equation at this stage is represented by, for example, Fxb2=max (Fxb1, Fxba), using a function “max” that selects the larger value.

At distribution functional unit (4)′, distribution operation is conducted between main control system (1) that is the driving system control unit and main control system (2) that is the brake system control unit. Functional distribution unit (4)′ corresponds to distribution functional unit (4) of main control system (1). Distribution functional unit (4)′ outputs Fxb3 to arbitration functional unit (5)′ for distribution towards the brake system that is the calculated result, and outputs FxP to main control system (1) for distribution towards the driving system that is the calculated result. Further, brake availability Fxb_avail identified as information that can be output from the brake that is the subject of control of main control system (2) is provided to automatic cruise functional unit (7) identified as the agent unit and dynamics compensation functional unit (8) identified as the supporter unit. The equation at this stage is represented by Fxb3←f(Fxba, Fxb2), FxP=f(Fxba, Fxb2), using function f.

Arbitration functional unit (5)′ executes arbitration between Fxb3 output from distribution functional unit (4)′ and Fxb_vdm output from dynamics compensation functional unit (8) that is the support unit to output Fxb4 to the brake controller. When accompanied with additional information (flag, vdm_status flag) indicative of Fxb_vdm output from dynamics compensation functional unit (8) being valid, the arbitration function selects Fxb_vdm that is the output from dynamics compensation functional unit (8) with highest priority to calculate Fxb4. In other cases, Fxb3 that is the output from distribution functional unit (4)′ may be selected to calculate Fxb4, or Fxb3 output from distribution functional unit (4)′ may have Fxb_vdm reflected by a predetermined degree of reflection to calculate Fxb4. The equation at this stage is represented by, for example, Fxb4=max (Fxb3, Fxb_vdm), using a function “max” that selects the larger value.

FIG. 6 shows a control configuration of main control system (3). Main control system (3) covering control of the steering system is adapted to control by the procedure set forth below.

At steering basic driver model (1)′, basic steering driver model output (Δ0) is calculated based on HMI input information such as the steering angle (sa), vehicle speed (spd) that is shared information (9), horizontal G acting on the vehicle (Gy), and the like. The equation at this stage is represented by Δ0=f(sa, spd, Gy), using function f.

At correction functional unit (2)″, Δ0 is corrected to output Δ1 based on Risk_Idx [n] that is environmental information (6) from the adviser unit (for example, information transformed into the concept of risk, and the like). The equation at this stage is represented by Δ1=f(Δ0, Risk_Idx [n]), using function f.

Specifically, it is calculated by Δ11=Δ0×Risk_Idx [n]. The degree of risk is input from the adviser unit such as Risk_Idx [n]=0.8, Risk_Idx [2]=0.6, and Risk_Idx [3]=0.5.

Further, Δ12 that is a corrected version of Δ0 is calculated based on information transformed into the concept of stability and the like from the vehicle state (10). The equation at this stage is represented by Δ12=Δ0 ×Stable_Idx [n]. For example, Stable_Idx [1]=0.8, Stable_Idx [2]=0.6, and Stable_Idx [3]=0.5 are input.

The smaller of these Δ11 and Δ12 may be selected to be output as Δ1.

At correction functional unit (2)″, assignment intention information to automatic cruise functional unit (7) that is the agent function can be output when the driver has depressed the lane keep assist switch. Furthermore, the output may be corrected in accordance with an external disturbance such as the side wind at correction functional unit (2)″.

At arbitration functional unit (3)″, arbitration is executed between Δ1 output from correction functional unit (2)″ and Δa output from automatic cruise functional unit (7) that is the agent unit to output Δ2 to arbitration unit (5)″. When accompanied with additional information (flag, available_status flag) indicative of Δa that is the output from automatic cruise functional unit (7) being valid, the arbitration function selects Δa that is the output from automatic cruise functional unit (7) with the highest priority to calculate Δ2. In other cases, Δ1 that is the output from correction functional unit (2)″ may be selected to calculate Δ2, or Δ1 that is the output from correction functional unit (2)″ may have Δa reflected by a predetermined degree of reflection to calculate Δ2. The equation at this stage is represented by, for example, Δ2=f(Δ1, Δa).

At arbitration functional unit (5)″, arbitration is executed between Δ2 output from arbitration functional unit (3)″ and Δ_vdm output from dynamics compensation function unit (8) that is the supporter unit to provide Δ4 to the steering controller. When accompanied with additional information (flag, vdm_status flag) indicative of Δ_vdm output from dynamics compensation functional unit (8) being valid, the arbitration function selects Δ_vdm that is the output from dynamics compensation functional unit (8) with highest priority to calculate Δ4. In other cases, Δ2 may be selected that is the output from arbitration functional unit (3)″ to calculate Δ4, or Δ2 that is the output from arbitration functional unit (3)″ may have Δ_vdm reflected by a predetermined degree of reflection to calculate Δ4. The equation at this stage is represented by, for example, Δ4=max (Δ2, Δ_vdm), using a function “max” that selects the larger value.

The operation of a vehicle incorporating the integrated control system set forth above will be described hereinafter.

During driving, the driver manipulates accelerator pedal 200, brake pedal 580 and steering wheel 440 to control the driving system control-unit corresponding to the “running” operation that is the basic operation of a vehicle, the brake system control unit corresponding to the “stop” operation, and the steering system control unit corresponding to a “turning” operation, based on information obtained by the driver through his/her own sensory organs (mainly through sight). Basically, the driver controls the vehicle through HIM input therefrom. There may also be the case where the driver manipulates the shift lever of the automatic transmission to modify the gear ratio of transmission 240 in an auxiliary manner.

During the drive of a vehicle, various environmental information around the vehicle is sensed by various devices incorporated in the vehicle, in addition to the information obtained by the driver through his/her own sensory organs. The information includes, by way of example, the distance from the vehicle running ahead, sensed by a millimeter wave radar, the current vehicle position and the road state ahead (corner, traffic jam, and the like) sensed by the navigation device, the road inclination state sensed by a G sensor (level road, up-climbing road, down-climbing road), the outdoor temperature of vehicle sensed by an outdoor temperature sensor, local weather information of the current running site received from a navigation device equipped with a receiver, the road resistance coefficient (low μ road state and the like by road surface freezing state), the running state of the vehicle ahead sensed by a blind corner sensor, a lane-keep state sensed based upon an image-processed picture taken by an outdoor camera, the driving state of the driver sensed based upon an image-processed picture taken by an indoor camera (driver posture, wakeful state, nod-off state), the dosing state of a driver sensed by sensing and analyzing the grip of the driver's hand by a pressure sensor provided at the steering wheel, and the like. Such information is divided into environmental information around the vehicle, and information about the driver himself/herself. It is to be noted that both information are not sensed through the sensory organs of the driver.

Furthermore, the vehicle dynamic state is sensed by a sensor provided at the vehicle. The information includes, by way of example, wheel speed Vw, vehicle speed in the longitudinal direction Vx, longitudinal acceleration Gx, lateral acceleration Gy, yaw rate γ, and the like.

The present vehicle incorporates a cruise control system and a lane-keep assist system as the driving support system to support the driver's drive. These systems are under control of the agent unit. It is expected that a further development of the agent unit will lead to implementation of a complete automatic cruising operation, exceeding the pseudo automatic cruising. The integrated control system of the present embodiment is applicable to such cases. Particularly, implementation of such an automatic cruising system is allowed by just modifying the automatic cruise function of the agent unit to an automatic cruise function of a higher level without modifying the driving system control unit corresponding to main control system (1), the brake system control unit corresponding to main control system (2), the steering system control unit corresponding to main control system (3), the adviser unit, and the supporter unit.

Consider a case where there is a corner ahead in the currently-running road during driving. This corner cannot be identified by the eye sight of the driver, and the driver is not aware of such a corner. The adviser unit of the vehicle senses the presence of such a corner based on information from a navigation device.

When the driver steps on accelerator pedal 200 for acceleration in the case set forth above, the driver will depress brake pedal 580 subsequently to reduce the speed of the vehicle at the corner. At main control system (1), the basic drive driver model output Fxp0 is calculated by Fxp0=f(pa, spd, ig), based on the accelerator pedal opening angle (pa), vehicle speed (spd), gear ratio of the transmission (ig), and the like. Conventionally, a large request driving torque value will be calculated based on this FxP0 to cause opening of the throttle valve of engine 140, and/or reducing the gear ratio of transmission 240 to cause vehicle acceleration. In the present invention, the adviser unit calculates the degree of risk Risk_Idx [n] based on the presence of the corner ahead and outputs this information to correction functional unit (2). Correction functional unit (2) performs correction such that acceleration is not exhibited as the driver will expect from his/her depression on accelerator pedal 200.

When the supporter unit senses that the road surface is freezing and there is a possibility of slipping sideways by the vehicle longitudinal acceleration at this stage, Stable_Idx [n] that is the degree of risk related to stability is calculated and output to correction functional unit (2). Thus, correction functional unit (2) performs correction such that acceleration is not exhibited as the driver will expect from his/her depression on accelerator pedal 200.

When slippage of the vehicle is sensed, the supporter unit outputs to arbitration functional unit (5) a signal that will reduce the driving torque. In this case, Fxp_vdm from the supporter unit is employed with priority such that the power train is controlled to suppress further slippage of the vehicle. Therefore, even if the driver steps on accelerator pedal 200 greatly, arbitration is established such that the acceleration is not exhibited as the driver will expect from his/her depression on accelerator pedal 200.

Such a vehicle integrated control system will further specifically be described.

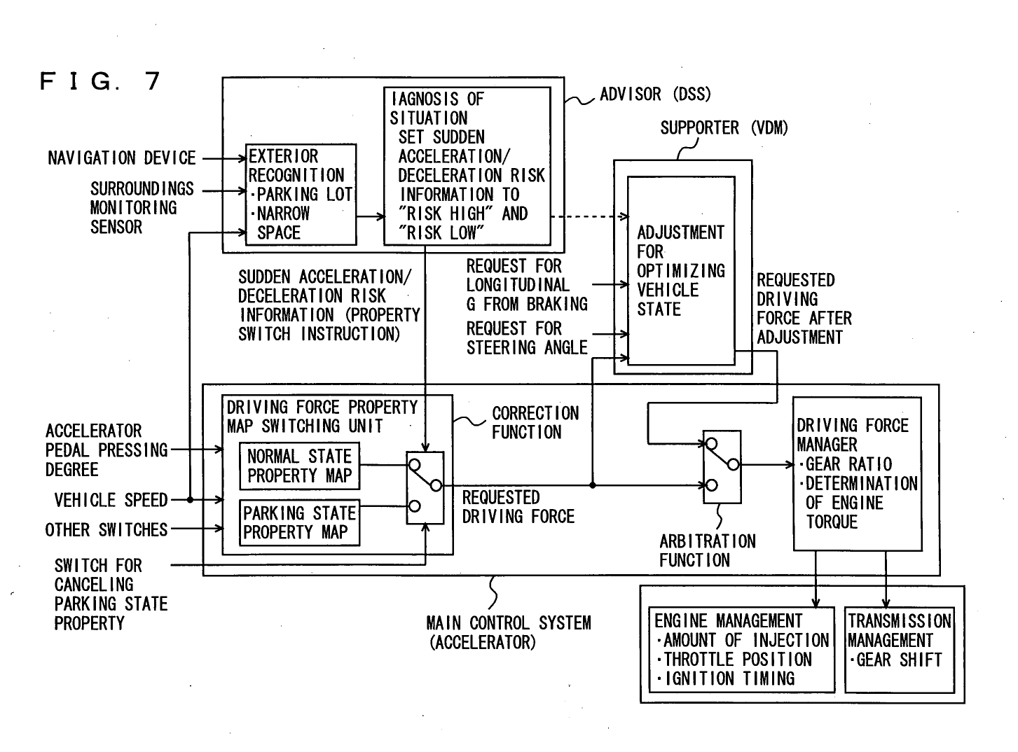

FIG. 7 is a block diagram showing a specific configuration of a control system controlling the main control system (1) (drive control unit) based on information from the advisor unit in the vehicle integrated control system (information transformed to a concept of sudden acceleration/deceleration risk, for example).

FIG. 7 shows the advisor unit, the supporter unit, and the main control system (1) (drive control unit) extracted from FIG. 2 above. As shown in FIG. 7, the advisor unit receives current vehicle position information or map information from the navigation device, information indicating that the vehicle is currently in a parking lot, or the like. In addition, the advisor unit receives information from an on-vehicle camera picking up an image of outside the vehicle, a millimeter wave radar device sensing an obstacle around the vehicle, or a clearance sensor serving as a surroundings monitoring sensor.

Based on such received information, the advisor unit generates risk information to be used in the main control system (1) (drive control unit), and outputs the generated information to the main control system (1) (drive control unit).

More specifically, the advisor unit recognizes that the vehicle is currently in the parking lot and a space is narrow, based on the information from the navigation device and the information from the surroundings monitoring sensor such as the on-vehicle camera, the millimeter wave radar device, or the clearance sensor as environmental information around the vehicle. Specifically, for example, the vehicle is now in a parking lot where a driver himself/herself should find a space and park the car, the driver finds a vacant parking space, and he is trying an operation for parking. In such a case, information representing that a degree of risk of sudden acceleration/deceleration is high is generated. The information representing that a degree of risk of sudden acceleration/deceleration is high is output to the main control system (1) (drive control unit). Here, the information representing the degree of sudden acceleration/deceleration risk is processed in the advisor unit in order to allow use thereof in any main control system.

The supporter unit generates information to be used in the main control system (1) (drive control unit) based on a dynamic state of the vehicle being in a parking operation, and outputs the generated information to the main control system (1) (drive control unit). The supporter unit grasps a current dynamic state of the vehicle, and generates information for modifying a target value in the main control system (1) (drive control unit). Here, in order to optimize the vehicle state, information representing a requested driving force after adjustment is output to the main control system (1) (drive control unit).

The main control system (1) (drive control unit) includes a driving force property map switching unit implementing a correction functional block, and an arbitration functional block.

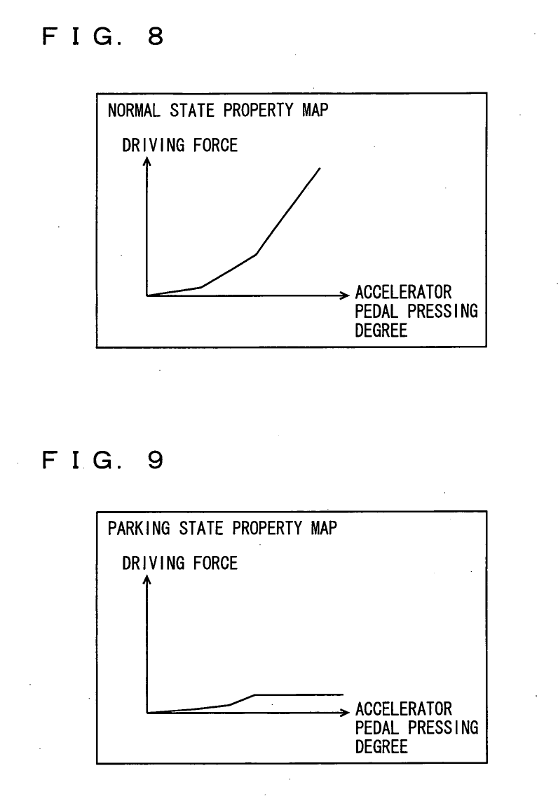

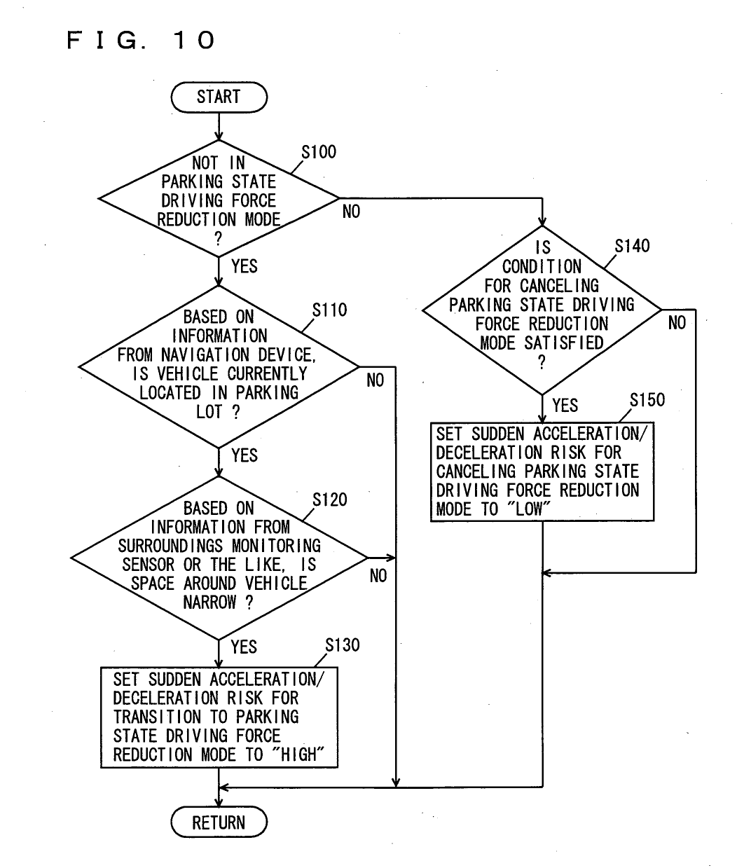

The driving force property map switching unit operating as the correction functional block (the driving force property map switching unit may operate as the arbitration functional block) switches the driving force property map between a normal state property map and a parking state property map, in accordance with the sudden acceleration/deceleration risk information from the advisor unit. FIG. 8 shows one example of the normal state property map, while FIG. 9 shows one example of the parking state property map. As can be seen from comparison of FIGS. 8 and 9, in the normal state property map shown in FIG. 8, as the degree of accelerator pedal pressing is high, the driving force (target driving force) is increased. On the other hand, in the parking state property map shown in FIG. 9, the driving force (target driving force) is not increased in an area where a certain degree of accelerator pedal pressing has been attained, even if the degree of accelerator pedal pressing is further higher. In other words, in such an area, the driving force (target driving force) is not increased even if the accelerator pedal is greatly pressed down. The driving force property map switching unit outputs a driving force (target driving force) obtained from the map shown in FIG. 8 or 9 to the arbitration functional block.

The arbitration functional block arbitrates between the requested driving force after adjustment for optimizing the vehicle state input from the supporter unit and the requested driving force (target driving force) input from the driving force property map switching unit. Here, one of the requested driving force after adjustment input from the supporter unit and the requested driving force (target driving force) input from the driving force property map switching unit is output to a driving force manager, based on information (flag) indicating on which information priority is placed in calculating the requested driving force. The driving force manager determines a gear ratio of transmission 240 or an engine torque, so that the power train attains the requested driving force (target driving force).

The driving force manager outputs control instruction values of a fuel injection amount, a throttle position, and engine ignition timing to an engine management unit. A torque generated from engine 100 can thus be controlled. In addition, the driving force manager outputs a control instruction value for instructing gear shift to a transmission management unit, so as to control a gear ratio of transmission 240. By controlling the torque generated from engine 100 and controlling the gear ratio of transmission 240, the driving torque in the power train can attain the target driving force obtained as a result of arbitration by the arbitration functional block.

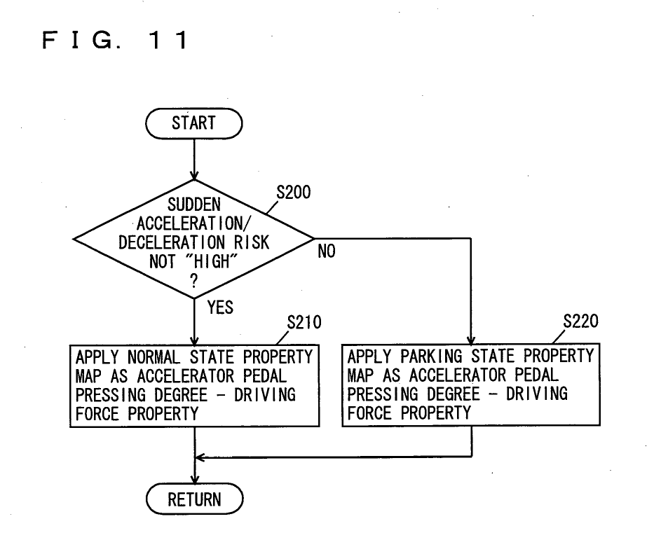

A control configuration of a program executed in an ECU (Electronic Control Unit) implementing the advisor unit and a control configuration of a program executed in the ECU implementing the main control system (1) (drive control unit) will now be described with reference to the flowcharts shown in FIGS. 10 and 11. An example of the ECU implementing the main control system (1) (drive control unit) is an engine ECU.

Referring to FIG. 10, at step (hereinafter, step is abbreviated as “S”) S100, the ECU of the advisor unit determines whether or not the vehicle is in a parking state driving force reduction mode. Such determination is made based on the information stored in a memory within the ECU of the advisor unit (such as a flag indicating that the vehicle is in the parking state driving force reduction mode). If the vehicle is not in the parking state driving force reduction mode (YES at S100), the process proceeds to S110. Otherwise (NO at S100), the process proceeds to S140.

At S110, the ECU of the advisor unit determines whether or not current position of the vehicle is the parking lot based on the information from the navigation device. Such determination is made based on the information from the navigation device input to the advisor unit (current position information, map information, etc.). If the current position of the vehicle is the parking lot (YES at S110), the process proceeds to S120. Otherwise (NO at S110), the process ends.

At S120, the ECU of the advisor unit determines whether or not a space around the vehicle is currently narrow based on the information from the on-vehicle camera, the millimeter wave radar device, or the clearance sensor serving as the surroundings monitoring device. If the space around the vehicle is currently narrow (YES at S120), the process proceeds to S130. Otherwise (NO at S120), the process ends.

At S130, the ECU of the advisor unit sets the sudden acceleration/deceleration risk for making a transition to the parking state driving force reduction mode to “high”. Thereafter, the process ends.

At S140, the ECU of the advisor unit determines whether or not a condition for canceling the parking state driving force reduction mode is satisfied. Here, a condition for canceling the parking state driving force reduction mode is determined as satisfied, when the current position of the vehicle is not the parking lot based on the information from the navigation device, when a space around the vehicle is sufficient even in the parking lot, or when the driver requests canceling of the parking state driving force reduction mode (by pressing a button for canceling the parking state driving force reduction mode, for example). When a condition for canceling the parking state driving force reduction mode is satisfied (YES at S140), the process proceeds to S150. Otherwise (NO at S140), the process ends.

At S150, the ECU of the advisor unit sets the sudden acceleration/deceleration risk for canceling the parking state driving force reduction mode to “low”. Thereafter, the process ends.

Referring to FIG. 11, at S200, the engine ECU determines whether or not the sudden acceleration/deceleration risk is “high”. Such determination is made based on the sudden acceleration/deceleration risk information input from the advisor unit to the engine ECU. When the sudden acceleration/deceleration risk is not “high” (YES at S200), the process proceeds to S210. Otherwise (NO at S200), the process proceeds to S220.

At S210, the engine ECU applies the normal state property map (FIG. 8) as the accelerator pedal pressing degree—driving force property. At S220, the engine ECU applies the parking state property map (FIG. 9) as the accelerator pedal pressing degree—driving force property.

An operation of a vehicle incorporating the vehicle integrated control system according to the present embodiment based on the above-described configuration and the flowcharts will now be described.

When the vehicle enters a parking lot where a driver himself/herself should find a space and park a car, and runs a passage in the parking lot (YES at S100, YES at S110, NO at S120), the sudden acceleration/deceleration risk information having the sudden acceleration/deceleration risk set to “low” is output to the engine ECU serving as the main control system (1) (drive control unit). In the engine ECU, the sudden acceleration/deceleration risk is not “high” based on the sudden acceleration/deceleration risk information input from the advisor unit (YES at S200). Therefore, the engine ECU applies the normal state property map (FIG. 8) as the accelerator pedal pressing degree—driving force property (S210). The engine ECU uses the normal state property map to calculate the requested driving force in accordance with an operated amount of the accelerator pedal by the driver, and outputs an obtained result to the arbitration functional block.

The arbitration functional block arbitrates between the requested driving force after adjustment input from the supporter unit and the requested driving force input from the driving property map switching unit serving as the correction functional block, and outputs the arbitration result to the driving force manager. Here, the driving force manager controls engine 100 and transmission 240 such that any one of the driving force requested by the driver of the vehicle through the accelerator pedal and the driving force adjusted and optimized by the supporter unit considering dynamic stability of the vehicle is output from the power train. In this manner, even within the parking lot, when the vehicle runs the passage, the driving force corresponding to the degree of accelerator pressing by the driver can be generated.

When a vacant parking space is found after running the passage in the parking lot (YES at S100, YES at S110, YES at S120), the sudden acceleration/deceleration risk information having the sudden acceleration/deceleration risk set to “high” is output to the engine ECU serving as the main control system (1) (drive control unit). In the engine ECU, the sudden acceleration/deceleration risk is “high” based on the sudden acceleration/deceleration risk information input from the advisor unit (NO at S200). Therefore, the engine ECU applies the parking state property map (FIG. 9) as the accelerator pedal pressing degree—driving force property (S210). The engine ECU uses the parking state property map to calculate the requested driving force in accordance with an operated amount of the accelerator pedal by the driver, and outputs an obtained result to the arbitration functional block. Here, in an area where a certain degree of pressing of the accelerator pedal has been attained, corresponding increase in the driving force is not seen.

The arbitration functional block arbitrates between the requested driving force after adjustment input from the supporter unit and the requested driving force input from the driving property map switching unit serving as the correction functional block, and outputs the arbitration result to the driving force manager. Here, the driving force manager controls engine 100 and transmission 240 such that any one of the driving force requested by the driver of the vehicle through the accelerator pedal and the driving force adjusted and optimized by the supporter unit considering dynamic stability of the vehicle is output from the power train. In this manner, even within the parking lot, when the driver is performing an operation to park the car, the driving force generated in accordance with the degree of pressing of the accelerator pedal is restricted so as to avoid sudden acceleration, without generating the driving force corresponding to the degree of pressing of the accelerator by the driver.

In this manner, when the vehicle that has been parked leaves the parking space and runs the passage in the parking lot (NO at S120), the normal state property map (FIG. 8) is applied, so as to generate the driving force in accordance with the degree of pressing of the accelerator by the driver.

Here, as shown in FIG. 7, a switch for canceling the parking state property may be provided in the car. The normal state property map (FIG. 8) may be applied when the driver presses this switch, so that the driving force in accordance with the degree of pressing of the accelerator by the driver is generated.

Thus, the vehicle integrated control system of the present embodiment operates as follows: at main control system (1) identified as the driving system control unit, accelerator pedal manipulation that is a request of a driver is sensed, and a control target of the driving system corresponding to the accelerator pedal manipulation is generated using a driving basic driver model, whereby the power train that is a drive actuator is controlled. At main control system (2) identified as the brake system control unit, brake pedal manipulation that is a request of the driver is sensed, and a control target of the brake system corresponding to the brake pedal manipulation is generated using a brake basic driver model, whereby the brake device that is the braking actuator is controlled. At main control system (3) identified as the steering system control unit, steering manipulation that is a request of the driver is sensed, and a control target of the steering system corresponding to the steering manipulation is generated using a steering basic driver model, whereby the steering device that is an actuator is controlled. These control units operate autonomously.

In addition to the driving system control unit, brake system control unit, and steering system control unit operating autonomously, there are further provided an adviser unit, an agent unit, and a supporter unit. The adviser unit generates and provides to respective control units information to be used at respective control units based on environmental information around the vehicle or information related to the driver. The adviser unit processes information representing the degree of risk with respect to operation characteristics of the vehicle based on the frictional resistance of the running road, outer temperature and the like as environmental information around the vehicle, and/or information representing the degree of risk with respect to the manipulation of a driver based on the fatigue level of the driver upon shooting a picture of the driver so as to be shared among respective control units. The agent unit generates and provides to respective control units information to be used at respective control units to cause the vehicle to implement a predetermined behavior. The agent unit generates information to implement an automatic cruise functions for automatic cruising of vehicle. Information to implement the automatic cruise function is output to respective control units. The supporter unit generates and provides to respective control units information to be used at respective control unit based on the current dynamic state of the vehicle. The supporter unit identifies the current dynamic state of the vehicle to generate information required to modify the target value at respective control units.

At respective control units, arbitration processing is conducted as to whether information output from the adviser unit, agent unit and supporter unit is to be reflected in the motion control of the vehicle, and if to be reflected, the degree of reflection thereof. These control unit, adviser unit, agent unit and supporter unit operate autonomously. Eventually at respective control units, the power train, brake device, and steering device are controlled based on the eventual drive target, braking target, and steering target calculated by information input from the adviser unit, agent unit and supporter unit, as well as information communicated among respective control units.

Thus, the driving system control unit corresponding to a “running” operation that is the basic operation of the vehicle, the brake system control unit corresponding to a “stop” operation, and the steering system control unit corresponding to a “turning” operation are provided operable in a manner independent of each other. With respect to these control units, the adviser unit, agent unit and supporter unit are provided, that can generate and output to respective control units information related to the risk and stability with respect to environmental information around the vehicle and information related to the driver, information to implement automatic cruise function for automatic cruising of the vehicle, and information required to modify the target value of respective control units to these control units. Therefore, a vehicle integrated control system that can readily accommodate automatic cruising control of high level can be provided.

More specifically, when the vehicle is parked in a vacant parking space in the parking lot or it is re-started after parking, the sudden acceleration/deceleration risk information having the risk set to “high” is input from the advisor unit to the main control system (1). In the main control system (1), the parking state accelerator pedal pressing degree—driving force map is used for integrated control of the vehicle. Therefore, sudden acceleration in parking due to misoperation by the driver can be avoided.

In the specific vehicle integrated control system as described above, canceling of the parking state property may be determined based on the vehicle speed, or based on a duration (time and distance) of a state in which the driving force property is low. In addition, in canceling the parking state property, recovery to the normal state property may gradually be carried out. Moreover, the driver may be notified that the vehicle is in a state in which the driving force property is low or that such a state has been cancelled (by display, etc.).

In the case where the flag from the adviser unit, agent unit and supporter unit is reset with the manipulation of the driver given highest priority, preferably, control using a signal from this driving support unit will not be conducted.

In addition to the parking lot as described above, the integrated control system according to the embodiment of the present invention is particularly effective in a place crowded with people and vehicles such as main routes or shopping streets. This is because the degree of freedom in running of one's own car should be restricted, considering a positional relation of one's own car and its surroundings. That is, in such a place, an operation of the vehicle is automatically restricted.

Although the present invention has been described and illustrated in detail, it is clearly understood that the same is by way of illustration and example only and is not to be taken by way of limitation, the spirit and scope of the present invention being limited only by the terms of the appended claims.

1. A vehicle integrated control system comprising:
a plurality of control units controlling a running state of a vehicle based on a manipulation request; and
a processing unit generating information to be used at each said control unit in prohibiting an operation of said vehicle based on information on a position of said vehicle, and providing the generated information to each said control unit; wherein
each said control unit includes
a sensing unit for sensing an operation request with respect to at least one control unit, and
a calculation unit for calculating information related to a control target to manipulate an actuator set in correspondence with each unit using at least one of said information generated at said processing unit and said sensed operation request.

2. The vehicle integrated control system according to claim 1, wherein
said processing unit senses position information of said vehicle, and generates information to be used in each said control unit in prohibiting a start operation or a stop operation, based on said position information of said vehicle.

3. The vehicle integrated control system according to claim 1, wherein
said processing unit senses that said vehicle is positioned at a specific place where a degree of freedom in running of said vehicle is restricted, based on said position information of said vehicle and senses an obstacle around said vehicle, and when said vehicle is positioned at said specific place and when an obstacle around the vehicle is sensed, said processing unit generates information to be used in each said control unit in prohibiting the start operation or the stop operation.

4. The vehicle integrated control system according to claim 1, wherein
said processing unit further includes a canceling unit generating information for canceling prohibition of said start operation or said stop operation.

5. The vehicle integrated control system according to claim 4, wherein
said canceling unit senses an operation request with respect to at least one control unit, and generates information for canceling prohibition of said start operation or said stop operation based on said operation request.

6. The vehicle integrated control system according to claim 4, wherein
said canceling unit senses a speed of said vehicle, and generates information for canceling prohibition of said start operation or said stop operation based on said speed of the vehicle.

7. The vehicle integrated control system according to claim 4, wherein
said canceling unit senses a continued state of prohibition of said start operation or said stop operation, and generates information for canceling prohibition of said start operation or said stop operation based on said continued state.

8. The vehicle integrated control system according to claim 7, wherein
said continued state represents a quantity of state based on a distance of travel or a time period of travel.

9. The vehicle integrated control system according to claim 1, gradually carrying out cancel of a state in which said operation is prohibited.

10. The vehicle integrated control system according to claim 1, informing a driver of any one of a state in which said operation is prohibited and a state in which prohibition has been cancelled.

11. A vehicle integrated control system comprising:
a plurality of control units controlling a running state of a vehicle based on a manipulation request; and
a processing unit generating information to be used at each said control unit in prohibiting an operation of said vehicle based on information on a position of said vehicle, and providing the generated information to each said control unit; wherein
each said control unit includes
sensing means for sensing an operation request with respect to at least one control unit, and
calculation means for calculating information related to a control target to manipulate an actuator set in correspondence with each unit using at least one of said information generated at said processing unit and said sensed operation request.

12. The vehicle integrated control system according to claim 11, wherein
said processing unit includes
means for sensing position information of said vehicle, and
means for generating information to be used in each said control unit in prohibiting a start operation or a stop operation, based on said position information of said vehicle.

13. The vehicle integrated control system according to claim 11, wherein
said processing unit includes
means for sensing that said vehicle is positioned at a specific place where a degree of freedom in running of said vehicle is restricted, based on said position information of said vehicle,
means for sensing an obstacle around said vehicle, and
means for generating information to be used in each said control unit in prohibiting the start operation or the stop operation when said vehicle is positioned at said specific place and when an obstacle around the vehicle is sensed.

14. The vehicle integrated control system according to claim 11, wherein
said processing unit further includes canceling means for generating information for canceling prohibition of said start operation or said stop operation.

15. The vehicle integrated control system according to claim 14, wherein
said canceling means includes means for sensing an operation request with respect to at least one control unit and generating information for canceling prohibition of said start operation or said stop operation based on said operation request.

16. The vehicle integrated control system according to claim 14, wherein
said canceling means includes means for sensing a speed of said vehicle and generating information for canceling prohibition of said start operation or said stop operation based on said speed of the vehicle.

17. The vehicle integrated control system according to claim 14, wherein
said canceling means includes means for sensing a continued state of prohibition of said start operation or said stop operation and generating information for canceling prohibition of said start operation or said stop operation based on said continued state.

18. The vehicle integrated control system according to claim 17, wherein
said continued state represents a quantity of state based on a distance of travel or a time period of travel.

19. The vehicle integrated control system according to claim 11, further comprising means for gradually carrying out cancel of a state in which said operation is prohibited.

20. The vehicle integrated control system according to claim 11, further comprising means for informing a driver of any one of a state in which said operation is prohibited and a state in which prohibition has been cancelled.
